(19) United States
(12) Patent Application Publication
(10) Pub. No.: US 2003/0009376 A1
(43) Pub. Date: Jan. 9, 2003

(54) System and method for retaining memberships at health clubs

(76) Inventor: Richard M. Ekstrom, Cornelius, NC (US)

Correspondence Address: Adams, Schwartz & Evans, P.A., 2180 Two First Union Center, Charlotte, NC, 28282, US

(21) Appl. No.: 09/900,675

(22) Filed: Jul. 6, 2001

(51) Int. Cl. G06F 17/60

(52) U.S. Cl. 705/14; 705/1

(57) ABSTRACT

A system for retaining memberships at a health club utilizes attendance data of club members at the health club. The club members are categorized into one of a plurality of member segments based on their level of attendance. A computer electronically transmits text messages to the club members in each of the plurality of member segments. The messages are customized to respective member segments such that non-users and low users of the club are encouraged to increase their attendance level, while regular users are encouraged to maintain their attendance level.

### TECHNICAL FIELD AND BACKGROUND OF THE INVENTION

This invention relates to a system and method for retaining memberships at health clubs. The invention represents a vision that embraces the future of the health club industry in a world driven by technology. A goal of the invention is to actualize this vision with a technology that sustains and enhances a health club operator's profitability and success in the market place through increased member retention.

The invention is an Internet-based solution to club membership attrition which utilizes targeted email to extend the customer relationship beyond the walls of the health club. Email is a dynamic medium that enables efficient, effective, one-on-one interactions with members on a mass level while maintaining the personal touches that make customer interactions exceptional. For example, an excerpt from an email message to a member might read: “Mike, we missed seeing you at the club this week and hope everything is okay. It is important that you maintain a consistent approach to your workouts in order to reach your goal.” The invention utilizes this personal interaction with club members to retain memberships.

A one percent improvement in membership retention can yield between five percent and fifteen percent improvement in profitability. Consider the following example. Health Club XYZ has 2,000 members, and yields a pretax profit of $80,000. Annual revenue per membership is $500. A one percent improvement in member retention will save the health club 20 members at $500 per member, or a total of $10,000. In this case, pretax profit increases from $80,000 to $90,000—a 12.5% increase.

While the health club industry has made increasing strides in the number of members, the challenge has been to retain these members long term. The costs involved in prospecting members, including advertising, marketing, sales, commissions and overhead far outweigh the cost of retaining members. Increasing individual member usage is essential to improving member retention. The International Health, Racquet & Sportsclub Association's (IHRSA) 2000 year-end industry survey revealed that less than half of the 30.6 million American health club members attend their club 100 days or more per year.

Although Americans recognize the importance of health and fitness in their lives and join a health club with the intention of exercising more frequently, many have a difficult time making exercise a regular habit. Studies have repeatedly demonstrated that approximately 50% of those individuals who start a self-monitored exercise program will drop out of that program within six months. For those who are successful in making exercise a regular habit, their exercise frequency (often 1 to 2 workouts per week) does not meet even the minimum recommendations of the American Heart Association and in most cases will not deliver the individual's desired results. As many club members reflect on their infrequent use of their health club membership and their failed attempt at yet another New-Year's resolution to “get in shape,” many decide to cancel their memberships. Even health clubs are generally dissatisfied and frustrated with their member's lack of progress, and recognize the need to improve member attendance.

Health clubs have attempted to counteract cancellations and low attendance through programs that involve individual phone calls to members. The goal has been to “connect” with members or build a relationship with them. However, these strategies have proven to be inconsistent and inefficient long term solutions due to the intense labor demands they impose on club staff and the lack of ongoing, regular support with members. It is nearly impossible for fitness staff members to provide ongoing, individualized support, recognition and advice to every member, particularly when members do not regularly visit the club. A member's needs transform as he or she progresses through the various stages of the membership cycle and it is difficult, yet necessary, for a health club to be proactive in addressing an individual's progress or decline if it seeks to aggressively counteract attrition.

Recently, the health and fitness industry has been transformed by technology. From an influx of websites to administrative reporting technologies, companies such as FITLINXX and CSI have been changing the way the industry does business.

According to FITLINXX, system installation at a club requires hardware mounted onto selected strength and cardiovascular equipment and a Fitlinxx kiosk. Approximately 300 clubs nationwide have installed the service, which is estimated to cost approximately $65,000. The system acts as a “personal trainer” to members as they proceed through workouts. Members log in and as they workout, the Fitlinxx system tracks their exercise and guides their intensity level. The Fitlinxx system also has component-enabling fitness counselors to check up on their club member's workouts and email their members. However, this component of the system is not widely used because it requires fitness counselors to respond individually to each member's workout and because fitness counselors typically have very limited access to a computer during the day.

The FITLINXX website serves health club members, general individuals interested in monitoring their workouts, and individual clubs. The site offers clubs the opportunity to develop a limited website with password access for their members. The site enables individuals to manually log a workout online from their home computers, and offers a host of valuable health and fitness information.

While the FITLINXX system certainly enables members to view their workout progress and helps them through a workout, the system does not address how often members are working out (attendance) nor does it establish a personalized relationship between club members and the club staff. Unlike the FITLINXX system, the present invention rewards and encourages members to workout and does so through personalized email interaction. The success of FITLINXX in the club and online is dependent upon the club staff's support and promotion of the system. The invention, on the other hand, is a self-sufficient program that actually speaks on behalf of the club staff.

The FITLINXX website system does offer club members valuable health and fitness information, but only if members are willing to take the initiative to go to the website. Also, the information is not customized to the individual member's needs or interests. The invention not only identifies member's interests from the onset, but has designed informative programs such as “Fitness Basics” to deliver information that is relevant and important to a member's stage in the membership cycle.

Another prior art system by ASIMBA is the premier example of a genre of online websites that cater to individuals interested in health, fitness and sports. This website offers a fee-based online subscription to a personalized fitness program and an online nutrition program. The website also offers free online memberships with access to ASIMBA's e-newsletters, health and fitness information. ASIMBA promotes 24-hour fitness clubs as well as other fitness apparel, nutrition and athletic gear companies. While ASIMBA and its related services cater to anyone interested in health and fitness, the present invention only serves health club members and is an email based product verses a website based service.

Club management systems such as CSI, LEGEND, and ASPEN INFORMATION SYSTEMS enable clubs to manage member information, billing, EFT and other administrative processes. The automation of these processes has organized member information into a rich database. The systems are primarily in-house and have limited or non-existent e-mail capabilities. Such club management systems were designed to handle the administrative tasks of member service such as scheduling appointments, billing, and other processes.

The system of the present invention does not face direct competition from these products currently used in the industry, and is actually positioned to successfully coexist in a club atmosphere with any or all of the systems mentioned. The present system is actually created to coordinate with club management systems, putting the member database to work for the club through emails that are customized for the members based upon the database information. Unlike other customer service based products, the invention works directly with members to offer support and assistance. The invention is an Internet-enabled system that does not have a presence inside the club. There are no hardware installations or difficult software programs to learn.

In essence, the invention is the “missing piece” of the technology systems present in the fitness industry today. While FITLINXX enhances the member workout experience, the invention provides the support, customized education and encouragement necessary to help members maintain and improve the frequency of their workouts. The invention develops the vital relationship between the club staff and members and ultimately improves the club's bottom line through member retention. The invention is aligned to be the technology solution that creates a seamless support system for health club members throughout the cycle of their membership. The system's focus on member attendance, communication with members and the automation of attrition defense systems makes the present system the industry's most comprehensive and innovative approach to improving retention and club revenues.

According to the 2000 Industry Data Survey by IHRSA, industry revenues grew an average of 10.2%, net membership was up 9.1% and clubs increased revenue per member to an average of $810 per year. This continued growth of members and the increasing value of those members creates a strong need for clubs to find a consistent and cost-effective way to reduce member attrition. Competition between clubs is also a factor driving the need to improve member retention, as the number of health clubs in the U.S. has reached nearly 16,000. The 30.6 million Americans who compose the commercial health club market are an exceptionally valuable consumer segment because of their affluence, education, active lifestyle and affinity for technology. The present invention completely automates and facilitates a club's retention strategy through a technology system hosted outside of the club, eliminating the expense of hardware and installation.

The invention combines a balance of education with support and accountability with recognition to provide an exceptional customer experience beyond the walls of the club. Club staff members are better able to focus on customers in the club with the automated retention system at work to effectively and aggressively help members maintain their club attendance levels and achieve fitness results. This cost-effective, retention revelation is the technology piece the industry has been missing. As the industry's membership growth continues to flourish, the present invention will be the key to retaining those members.

### SUMMARY OF THE INVENTION

Therefore, it is an object of the invention to provide an Internet-based solution to club membership attrition which utilizes targeted email to extend the customer relationship beyond the walls of the health club. The invention is an effortless, consistent, email-based member retention solution enabling a club staff to automatically develop a vital connection with members to support them throughout their membership cycle.

It is another object of the invention to provide a club membership retention system which furnishes ongoing support and information to members.

It is another object of the invention to provide a club membership retention system which provides club staff with valuable reports regarding the membership cycle, interests and progress of club members. This detailed information is designed to assist the club staff in accommodating their member's needs.

It is another object of the invention to provide a club membership retention system which automatically sends members club update information, birthday, holiday and anniversary greetings.

It is another object of the invention to provide a club membership retention system which utilizes a cost-effective, Internet-enabled software program that collaborates with existing club management software systems to create individualized email messages to members regarding their progress and goals.

It is another object of the invention to provide a club membership retention system which automatically contacts club staff in certain cases to prompt the staff to make contact with a member by telephone.

These and other objects of the present invention are achieved in the preferred embodiments disclosed below by providing a system for retaining memberships at a health club. The system includes means for determining attendance of club members at the health club. The club members are categorized into one of a plurality of member segments based on their level of attendance. A computer electronically transmits text messages to the club members in each of the plurality of member segments. The messages are customized to respective member segments such that non-users and low users of the club are encouraged to increase their attendance level, while regular users are encouraged to maintain their attendance level.

The “means for determining attendance” includes any suitable electronic or manual means for accessing and retrieving attendance data. The attendance data may be acquired using standard attendance monitoring systems. Typical monitoring systems include an electronic device, such as a card scanner, a computer for data storage and software processing, and standard club management software. One example of an existing club management and attendance monitoring system is described in U.S. Pat. No. 4,831,242. The complete disclosure of this patent is incorporated herein by reference. While less efficient, an alternative attendance monitoring means may include a manual record of member attendance using, for example, a sign-in sheet. In this case, the attendance determining means would require a manual review of multiple sign-in sheets over a specified period.

Preferably, the means for categorizing members utilizes a computer and basic programming to automatically enter members into one of the appropriate member segments.

According to another preferred embodiment of the invention, the plurality of member segments include at least two selected from the group consisting of a regular user segment, a low user segment, and a non-user segment.

According to another preferred embodiment of the invention, the text message to club members in the regular user segment indicates the member's attendance level.

According to another preferred embodiment of the invention, the text message to club members in the regular user segment includes a customized wellness tip.

According to another preferred embodiment of the invention, the text message to club members in the regular user segment includes club information.

According to another preferred embodiment of the invention, the text message to club members in the low user segment indicates the member's attendance level.

According to another preferred embodiment of the invention, the text message to club members in the low user segment includes an exercise motivation tip.

According to another preferred embodiment of the invention, the text message to club members in the low user segment includes a customized wellness tip.

According to another preferred embodiment of the invention, the text message to club members in the low user segment includes club information.

According to another preferred embodiment of the invention, the text message to club members in the non-user segment indicates the member's attendance level.

According to another preferred embodiment of the invention, the text message to club members in the non-user segment requests members to identify obstacles preventing more frequent usage.

In another embodiment, the invention is a method for retaining memberships at a health club. The method includes the steps of determining attendance of club members at the health club, and categorizing the club members into one of a plurality of member segments based on their level of attendance. Text messages are then electronically transmitted to the club members in each of the plurality of member segments. The text messages are customized to respective member segments such that non-users and low users of the club are encouraged to increase their attendance level, while regular users are encouraged to maintain their attendance level.

According to another preferred embodiment of the invention, the method includes establishing a new member program for new members of the health club

According to another preferred embodiment of the invention, the method includes providing a fitness orientation for new members of the health club.

According to another preferred embodiment of the invention, the method includes electronically transmitting text messages to new members encouraging usage of the health club.

According to another preferred embodiment of the invention, the text messages for new members include basic fitness tips

According to another preferred embodiment of the invention, the text messages are electronically transmitted to new members at least once a week.

According to another preferred embodiment of the invention, the method includes notifying club staff of those members in the non-user segment.

According to another preferred embodiment of the invention, the method includes contacting by telephone those members in the non-user segment.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a flow diagram illustrating the general operation of a health club membership retention system according to one preferred embodiment of the invention;

FIG. 2 is a flow diagram illustrating a program of the System designed for new members of the health club;

FIG. 3 is a flow diagram illustrating a program of the System designed for regular user members of the health club;

FIG. 4 is a flow diagram illustrating a program of the System designed for low user members of the of the health club; and

FIG. 5 is a flow diagram illustrating a program of the System designed for non-user members of the health club.

### DESCRIPTION OF THE PREFERRED EMBODIMENT AND BEST MODE

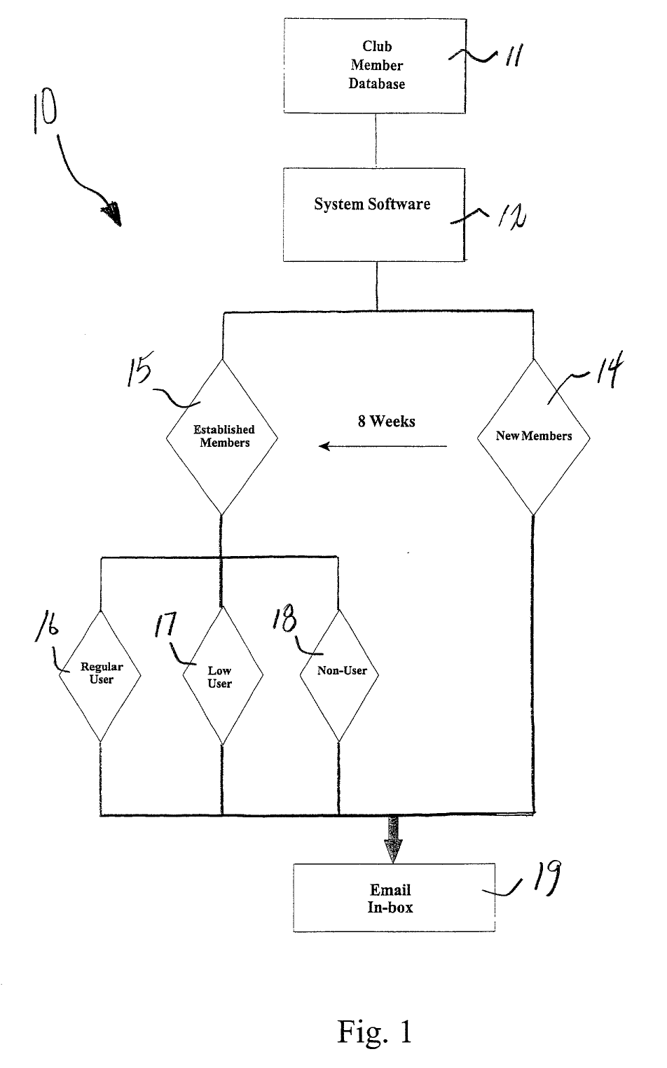

Referring now specifically to the drawings, a health club membership retention system (“System”) according to the present invention is illustrated generally in FIG. 1 and indicated at broad reference number 10. The term “health club” is broadly defined herein to include any special interest or fitness related organization. The System 10 tracks the attendance of club members and directly responds to their progress and needs via targeted emails. The System 10 is especially unique because it identifies and coaches members during the most critical stages of their membership cycle. By utilizing a club's existing electronic database 11 and member management software, such as CSI or LEGEND, the System 10 aggressively monitors attendance and membership. System software 12 interacts daily with the member database 11 to retrieve updated member information and attendance data. Using this information, new members 14 are separated from established members 15, and the established members 15 grouped into one of three member segments 16, 17, and 18. The member's segment, attendance patterns and goals help to coordinate the schedule and the content of regular email messages 19 sent to the member, from the club staff, to provide recognition, accountability and support. Because members have different needs throughout their membership, the grouping and segmentation process enables the System 10 to deliver a unique program to each member segment.

The established-member segments include regular users 16,low users 17, and non-users 18. Each of these segments 16, 17, and 18 and the new member group 14 is discussed further below.

New Member

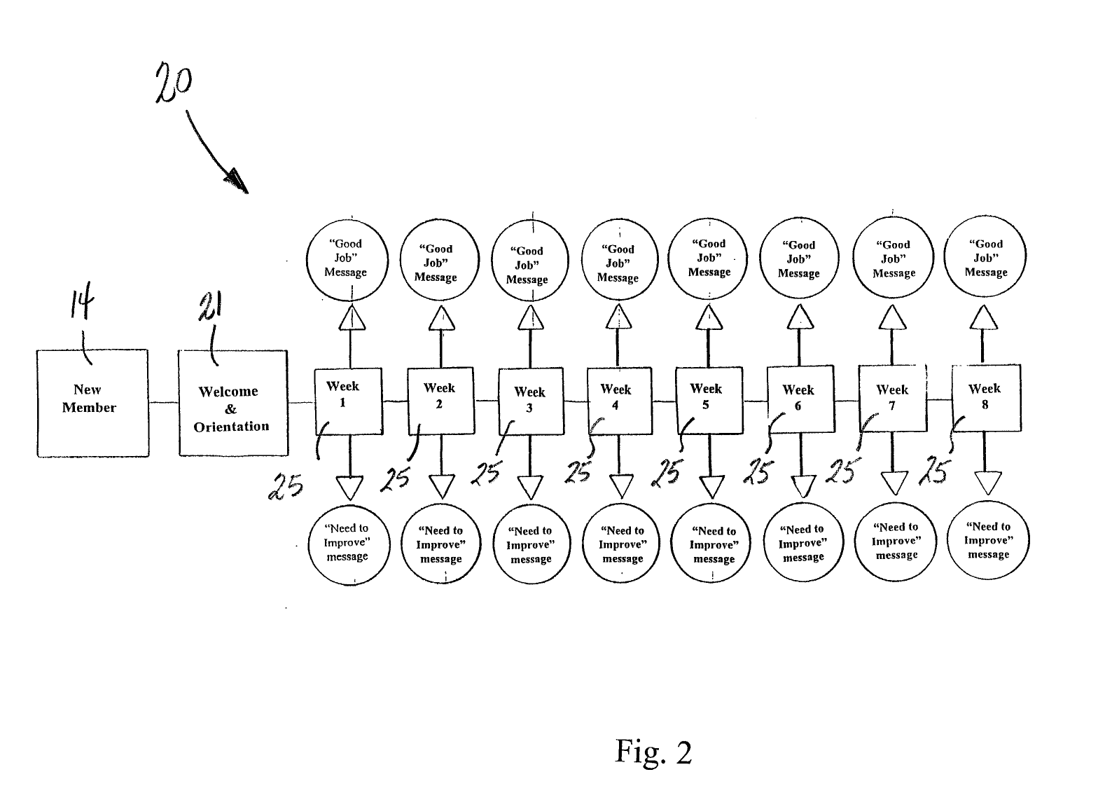

Referring to FIG. 2, new members 14 are automatically enrolled in a new member program 20 when the club staff enters their membership information into the club's existing management system. The new member program includes a welcome and introduction email 21, and optionally, a new member orientation reminder. The new member orientation is a useful tool for clubs who offer this introductory service. Members 14 also receive a short interest survey to help clubs identify their member's interests and to customize the content of future System emails. An example of a new member introduction letter is provided below.

Michelle,

Improving your fitness level can change your life. I would like to graciously welcome you to (club name) and congratulate you on taking the first steps to improving your health.

We are passionate about helping our members improve their fitness because we have witnessed and experienced the benefits of a healthy lifestyle. From improved energy levels and preventative wellness benefits to just feeling good about the way you look, exercise is like a fountain of youth.

We know your life is busy with the demands of work, family and friends, and that is why we have developed this convenient email program! This program will help you stay on track with your workouts and your fitness goals. We will provide you with safe, effective and efficient workout guidance as well as information to help you fully enjoy your membership.

Let's Get Started

We would like to help you get started with the professional guidance of one of our professional fitness instructors. If you did not sign up for your first complimentary fitness orientation appointment, we invite you to select the optimal day and time below and one of our instructors will contact you to arrange an appointment.

If you need to reschedule an appointment, please email us or call the front desk at (phone number).

Your complimentary fitness orientation session is designed for both novice and expert level exercisers as the instructor will not only introduce the club's equipment and programs, but will also design a workout a program to meet your individual schedule, goals and needs.

You will receive a short email questionnaire to help our fitness staff identify your health and fitness interests and goals. Please take a minute to fill this form out completely, as it will help us to help you achieve the results you desire.

If you need anything or have any questions or comments, I invite you to speak with me at your convenience. We look forward to serving you and will see you at the club!

In Health,

General Manager

The new member program 20 lasts 8-weeks. During this period, new members 14 receive two emails 25 per week from the System 10. The first of these emails offers recognition if the member 14 meets or exceeds an attendance standard set by the club. Motivation is provided if the member 14 is below the set attendance standard. For example, if a club sets attendance standards based upon the recommendations of the American Heart Association, members who workout 3 or more times per week are classified as new member/regular users and receive positive recognition for their dedication. Those members who workout less than 3 times per week are classified as new member/low users and receive encouragement to try and improve their number of weekly workouts. This email message also contains an element of the System's 8-week series called “Fitness Basics.” This series includes topics to help members learn the essential elements of exercise necessary to achieve their fitness goals. Topics range from “Benefits of Strength Training” to “Exercise Frequency, Intensity and Duration.” Fitness basics is designed to support and prepare the member as they gain confidence in working out and begin to set challenges for themselves. The second email of the week provides introductory information and updates from the member's club.

If during any week of the 8-week new member program 20 a new member 14 does not attend the club, then he or she is classified as a new member/non-user and an email is sent to the fitness staff with the recommendation to call this member. Additionally, if a member 14 does not visit the club at the minimum level set by the club for two consecutive weeks, an email is also sent to the fitness staff. Upon completion of the new member program 20, new members 14 become established members 15 and are subject to further classification and support programs based on their level of usage, as described below.

Regular User

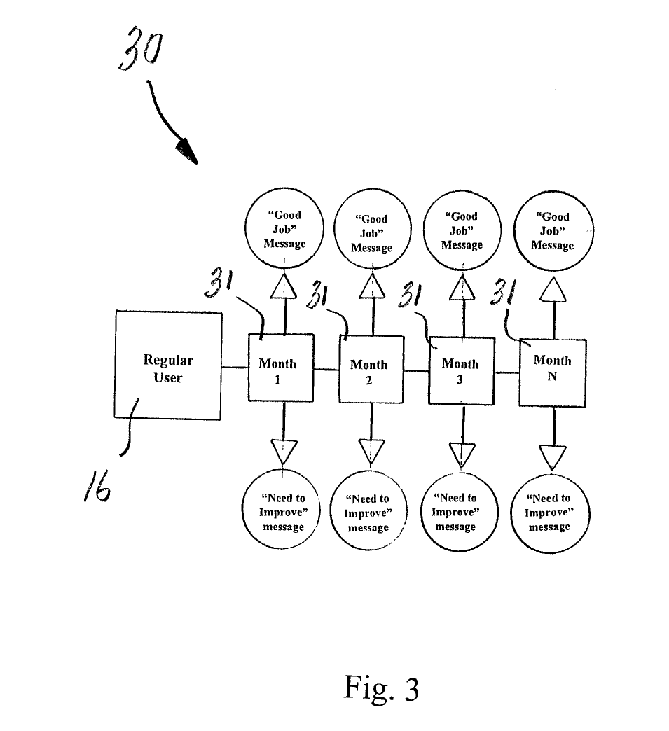

Referring to FIG. 3, established club members 15 may be entered into the regular user program 30 if they regularly attend the club at or above the standard set by the club. For example, a regular user 16 may attend 12 or more times a month. The System's regular user program 30 sends these members monthly email messages 31 offering attendance recognition, club information and fitness information. The format of a typical email message 31 to this member segment includes (a) the member's name; (b) attendance/motivation statement; (c) customized wellness tip; and (d) club information. The following is one example of an email message 31 automatically sent by the System 10 to a member 16 in the regular user program 30:

John,

You are on target for success with (number) workouts this month! Great Job!

Did you know that people who don't exercise lose 30 to 40 percent of their strength by age 65. By age 74, more than one-fourth of American men and two-thirds of American women can't lift an object heavier than 10 pounds!

The concept is simple: if you don't use your muscles, you lose them.

Strength training is an important part of a balanced fitness program. After all, even if you have the cardiovascular fitness to sprint the full length of an airport to catch your plane, it's not going to do you much good if you can't carry your luggage!

Your cardiovascular workouts burn a lot of calories each session, but strength training firms, lifts, builds and shapes your muscles. As you build and strengthen your muscles, they consume more calories on a daily basis, increasing your metabolism. That is why a balanced fitness program incorporates both types of exercise.

If you are interested in incorporating strength training into your weekly fitness program, please ask a fitness instructor to help you get started! Your body will thank you for it.

This month at (club's name) if you refer a member, you can receive a complimentary (list item)! Please see the (refer to source) for more information.

In Health,

General Manager

If a regular user 16 meets the monthly attendance requirement (e.g., 12+visits), but fails to meet the weekly requirement (e.g., 3+visits) for two or more weeks of the month, the System 10 sends an email message encouraging the user to improve his or her consistency. Regular users 16 meeting the monthly and weekly requirements are congratulated on their consistency and dedication to achieving their fitness goals. Those members who fail to meet the monthly attendance requirement are removed from the regular user program.

Low User

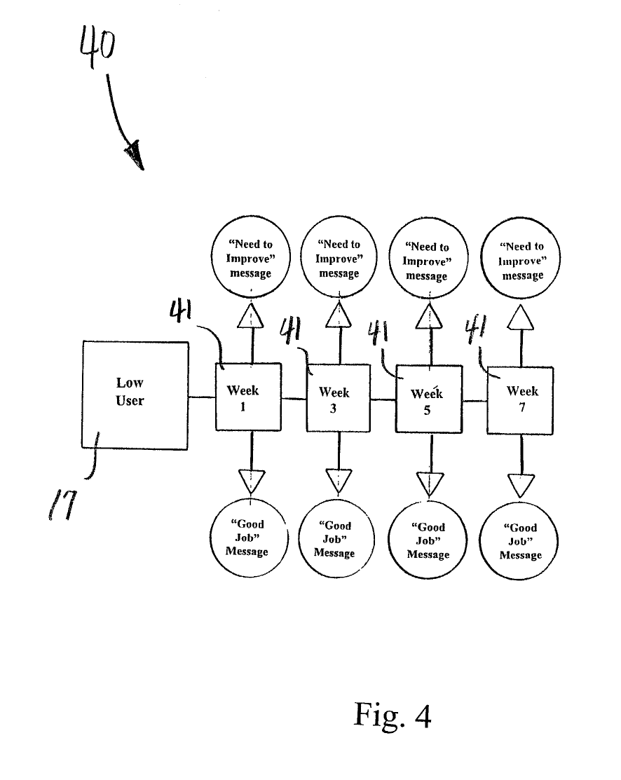

Referring to FIG. 4, club members who visit the club less than the minimum standard set by the club are entered into the low user program 40. This group of members 17 receives bimonthly emails 41 with attendance encouragement and club information. A typical first email of the month to a member 17 in this segment includes (a) the member's name; (b) attendance accountability and encouragement; and (c) a tip to help motivate the member to exercise. A typical second email of the month includes (a) the member's name; (b) attendance accountability and encouragement; (c) a wellness tip based upon interests and goals; and (d) club information. The following is an example of a first email of the month:

Melissa,

You have consistently worked out this month, however we want to remind you that to have the most impact on your fitness and health, you need to exercise at least three times a week.

Yes, you can do it. Yes, you do have the time. Getting fit will give you the energy to do the things you love! Make a plan of attack this week. Schedule your workouts this week as an important appointment in your calendar. Try to workout at a time that works best with your schedule. Work out with a friend or bring your favorite music to help you stay motivated. Get in the habit of visiting us three times a week and you will be on your way to reaching your goals!

See you at the club!

In Health,

General Manager

If after 8 weeks, a low user member 17 has improved attendance to meet or exceed the minimum monthly level for consecutive months, then he or she returns to the regular user program 30, described above. On the other hand, if a member 17 remains in the low user program 40 for 8 weeks without improvement, he or she is entered into a third System program 50, a non-user recovery phase similar to the 8-week new member program 20.

Non-User

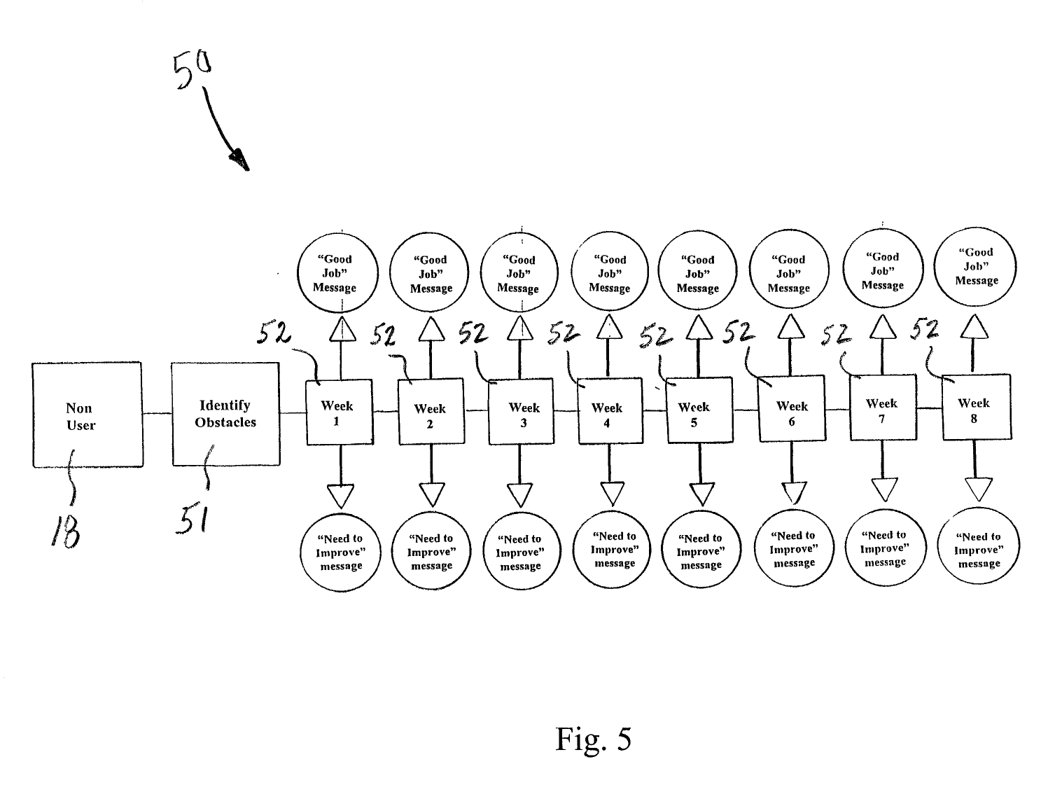

Referring to FIG. 5, established members 15 whose attendance has recurrently dipped below the standard set by the club are entered into the non-user recovery program 50. The fitness staff is notified of the member's status as a “non-user”member 18, and is directed to contact the member by telephone to offer encouragement. The recovery program 50 is similar to the new member program 20 because it is also an 8-week program that delivers 2 emails per week regarding a member's attendance and club information. One difference is that instead of offering Fitness Basics, the recovery program 50 helps members 18 get back on track with topics such as “Finding time to exercise.” Prior to entering the program 50, a survey 51 is provided asking members to identify their personal fitness goals and specific obstacles preventing more frequent attendance at the club. This information is shared with the club staff who work together with the member 18 during the recovery program 50 to increase club usage. Biweekly emails 52 include statements intended to motivate the member 18 by either congratulating him or her when attendance goals are met, or encouraging improvement. The recovery program 50 is a dynamic part of the System 10 as it is the active and attentive element of the System 10 that immediately contacts and attempts to revive a member's interest and commitment to their fitness goals.

A System for retaining memberships at a health club is described above. Various details of the invention may be changed without departing from its scope. Furthermore, the foregoing description of the preferred embodiment of the invention and the best mode of practicing the invention are provided for the purpose of illustration only and not for the purpose of limitation-the invention being defined by the claims.

I claim:

1. A system for retaining memberships at a health club, comprising:
(a) means for determining attendance of club members at the health club;
(b) means for categorizing the club members into one of a plurality of member segments based on their level of attendance; and
(c) a computer for electronically transmitting text messages to the club members in each of said plurality of member segments, said messages being customized to respective member segments such that non-users and low users of the club are encouraged to increase their attendance level, while regular users are encouraged to maintain their attendance level.

2. A system according to claim 1, wherein said plurality of member segments comprises at least two selected from the group consisting of a regular user segment, a low user segment, and a non-user segment.

3. A system according to claim 2, wherein said text message to club members in said regular user segment indicates the member's attendance level.

4. A system according to claim 3, wherein said text message to club members in said regular user segment includes a customized wellness tip.

5. A system according to claim 4, wherein said text message to club members in said regular user segment includes club information.

6. A system according to claim 2, wherein said text message to club members in said low user segment indicates the member's attendance level.

7. A system according to claim 6, wherein said text message to club members in said low user segment includes an exercise motivation tip.

8. A system according to claim 7, wherein said text message to club members in said low user segment includes a customized wellness tip.

9. A system according to claim 8, wherein said text message to club members in said low user segment includes club information.

10. A system according to claim 2, wherein said text message to club members in said non-user segment indicates the member's attendance level.

11. A system according to claim 10, wherein said text message to club members in said non-user segment requests members to identify obstacles preventing more frequent usage.

12. A method for retaining memberships at a health club, comprising:
(a) determining attendance of club members at the health club;
(b) categorizing the club members into one of a plurality of member segments based on their level of attendance; and
(c) electronically transmitting text messages to the club members in each of the plurality of member segments, the text messages being customized to respective member segments such that non-users and low users of the club are encouraged to increase their attendance level, while regular users are encouraged to maintain their attendance level.

13. A method according to claim 12, and comprising establishing a new member program for new members of the health club

14. A method according to claim 13, and comprising providing a fitness orientation for new members of the health club.

15. A method according to claim 13, and comprising electronically transmitting text messages to new members encouraging usage of the health club.

16. A method according to claim 15, wherein the text messages for new members include basic fitness tips

17. A method according to claim 16, wherein the text messages are electronically transmitted to new members at least once a week.

18. A method according to claim 12, wherein the member segments comprise at least two selected from the group consisting of a regular user segment, a low user segment, and a non-user segment.

19. A method according to claim 18, and comprising notifying club staff of those members in the non-user segment.

20. A method according to claim 19, and comprising contacting by telephone those members in the non-user segment.

21. A system for retaining memberships at a health club, comprising:
(a) means for categorizing the club members into one of a plurality of member segments based on their level of attendance; and
(b) a computer for electronically transmitting text messages to the club members in each of said plurality of member segments, said messages being customized to respective member segments such that non-users and low users of the club are encouraged to increase their attendance level, while regular users are encouraged to maintain their attendance level.

22. A method for retaining memberships at a health club, comprising:
(a) categorizing the club members into one of a plurality of member segments based on their level of attendance; and
(b) electronically transmitting text messages to the club members in each of the plurality of member segments, the text messages being customized to respective member segments such that non-users and low users of the club are encouraged to increase their attendance level, while regular users are encouraged to maintain their attendance level.
